(19) United States
(12) Patent Application Publication
(10) Pub. No.: US 2024/0275670 A1
(43) Pub. Date: Aug. 15, 2024

(54) SYSTEMS AND METHODS FOR DETERMINING AVAILABILITY STATUS OF ENTITIES IN A PIN

(71) Applicant: SAMSUNG ELECTRONICS CO., LTD., Suwon-si, Gyeonggi-do (KR)

(72) Inventors: Sidhant JAIN, Bangalore (IN); Lalith KUMAR, Bangalore (IN); Aman AGARWAL, Bangalore (IN); Anoop Perumudi VEEDU, Bangalore (IN); Arunprasath RAMAMOORTHY, Bangalore (IN); Kailash Kumar JHA, Bangalore (IN)

(21) Appl. No.: 18/570,005

(22) PCT Filed: Jul. 27, 2023
(86) PCT No.: PCT/KR2023/010949

§ 371 Date: Dec. 13, 2023

(30) Foreign Application Priority Data
Jul. 30, 2022 (IN) 202241043706
Aug. 2, 2022 (IN) 202241044158
Jul. 12, 2023 (IN) 202241043706

(51) Int. Cl. H04L 41/0803; G16Y 10/75; G16Y 40/35

(52) U.S. Cl. CPC H04L 41/0803; G16Y 10/75; G16Y 40/35

(57) ABSTRACT

The disclosure relates to a 5G or 6G communication system for supporting a higher data transmission rate. Methods (300) and systems for determining an availability status of a first entity associated with a personal internet of things (IoT) network (PIN) (210) are described. The method (300) may comprise determining (302), by second entity associated with the PIN (210), whether a periodic update request is received from the first entity prior to an expiry of a periodic update (PU) timer value. The method (300) may further comprise determining (304), by the second entity, the availability status of the first entity based on the determination whether the periodic update request is received from the first entity.

### TECHNICAL FIELD

The present invention generally relates to an internet of things (IoT) environment, and more specifically related to methods and systems for determining availability status of entities within a personal IoT network (PIN) and assigning PIN-related functionalities to different entities within the PIN.

### BACKGROUND ART

5G mobile communication technologies define broad frequency bands such that high transmission rates and new services are possible, and can be implemented not only in “Sub 6 GHZ” bands such as 3.5 GHz, but also in “Above 6 GHZ” bands referred to as mmWave including 28 GHZ and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The present disclosure relates to wireless communication systems and, more specifically, the present disclosure relates to availability status of entities within a personal IoT network (PIN) and PIN-related functionalities to different entities within the PIN.

### Solution to Problem

This summary is provided to introduce a selection of concepts, in a simplified format, that are further described in the detailed description of the invention. This summary is neither intended to identify key or essential inventive concepts of the invention and nor is it intended for determining the scope of the invention.

According to one embodiment of the present disclosure, a method for determining an availability status of a first entity associated with a personal internet of things (IoT) network (PIN) is disclosed. The method comprises determining, by a second entity associated with the PIN, whether a periodic update request is received from the first entity prior to an expiry of a periodic update (PU) timer value. The method further comprises determining, by the second entity, the availability status of the first entity based on the determination whether the periodic update request is received from the first entity.

According to another embodiment of the present disclosure, a method for determining an availability status of a personal internet of things (IoT) network (PIN) element with gateway capability (PEGC) associated with a PIN is disclosed. The method comprises determining, by a PIN element with management capability (PEMC) associated with the PIN, whether a periodic update request is received from the PEGC prior to an expiry of a periodic update (PU) timer value. The method further comprises determining, by the PEMC, the availability status of the PEGC based on the determination whether the periodic update request is received from the PEGC.

According to yet another embodiment of the present disclosure, a method for determining an availability status of a personal internet of things (IoT) network (PIN) element (PINE) associated with a PIN is disclosed. The method comprises determining, by a PIN element with management capability (PEMC) associated with the PIN, whether a periodic update request is received from the PINE prior to an expiry of a periodic update (PU) timer value. Further, the method comprises determining, by the PEMC, the availability status of the PINE based on the determination whether the periodic update request is received from the PINE.

According to yet another embodiment of the present disclosure, a method for determining an availability status of a personal internet of things (IoT) network (PIN) element with management capability (PEMC) associated with a PIN is disclosed. The method comprises determining, by a PIN server associated with the PIN, whether a periodic update request is received from the PEMC prior to an expiry of a periodic update (PU) timer value. Further, the method comprises determining, by the PIN server, the availability status of the PEMC based on the determination whether the periodic update request is received from the PEMC.

According to yet another embodiment of the present disclosure, a method for assigning a new personal internet of things (IoT) network (PIN) element with gateway capability (PEGC) for a PIN is disclosed. The PIN comprises a plurality of PIN elements (PINEs), a PIN element with management capability (PEMC), and a PIN server. The method comprises determining, by the PEMC, an availability status of a current PEGC within the PIN as unavailable. Further, the method comprises, upon determining the availability status of the current PEGC as unavailable, selecting, by the PIN server, a first PINE from among the plurality of PINEs to serve as a new PEGC for the PIN.

According to yet another embodiment of the present disclosure, a system to determine an availability status of a first entity associated with a personal internet of things (IoT) network (PIN) is disclosed. The system comprises a second entity configured to determine whether a periodic update request is received from the first entity prior to an expiry of a periodic update (PU) timer value. The second entity is further configured to determine the availability status of the first entity based on the determination whether the periodic update request is received from the first entity.

According to yet another embodiment of the present disclosure, a system to determine an availability status of a personal internet of things (IoT) network (PIN) element with gateway capability (PEGC) associated with a PIN is disclosed. The system comprises a PIN element with management capability (PEMC) associated with the PIN. The PEMC is configured to determine whether a periodic update request is received from the PEGC prior to an expiry of a periodic update (PU) timer value. The PEMC is further configured to determine the availability status of the PEGC based on the determination whether the periodic update request is received from the PEGC.

According to yet another embodiment of the present disclosure, a system to determine an availability status of a personal internet of things (IoT) network (PIN) element (PINE) associated with a PIN is disclosed. The system comprises a PIN element with management capability (PEMC) associated with the PIN. The PEMC is configured to determine whether a periodic update request is received from the PINE prior to an expiry of a periodic update (PU) timer value. The PEMC is further configured to determine the availability status of the PINE based on the determination whether the periodic update request is received from the PINE.

According to yet another embodiment of the present disclosure, a system to determine an availability status of a personal internet of things (IoT) network (PIN) element with management capability (PEMC) associated with a PIN is disclosed. The system comprises a PIN server associated with the PIN. The PIN server is configured to determine whether a periodic update request is received from the PEMC prior to an expiry of a periodic update (PU) timer value. Further, the PIN server is configured to determine the availability status of the PEMC based on the determination whether the periodic update request is received from the PEMC.

According to yet another embodiment of the present disclosure, a system for assigning a new personal internet of things (IoT) network (PIN) element with gateway capability (PEGC) for a PIN is disclosed. The PIN comprises a plurality of PIN elements (PINEs), a PIN element with management capability (PEMC), and a PIN server. The system comprises the PEMC configured to determine an availability status of a current PEGC within the PIN as unavailable. Further, the system comprises the PIN server configured to, upon a determination of the availability status of the current PEGC as unavailable, select a first PINE from among the plurality of PINEs to serve as a new PEGC for the PIN.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### Advantageous Effects of Invention

According to an embodiment of the disclosure, availability status of a entity can be determined efficiently.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates an existing operational flow diagram depicting a process when any entity disconnects from a personal internet of things (IoT) network (PIN), in accordance with an existing prior-art.

FIG. 2A illustrates a schematic block diagram of an environment associated with a personal internet of things (IoT) network (PIN), according to an embodiment of the present invention;

FIG. 2B illustrates a schematic block diagram of systems within the environment, according to an embodiment of the present invention;

FIG. 3 illustrates a process flow comprising a method for determining the availability status of a first entity, according to an embodiment of the present invention;

FIG. 4A illustrates a process flow comprising a method for determining the availability status of a PEGC, according to an embodiment of the present invention;

FIG. 4B illustrates a process flow comprising a method for assigning a new PEGC for the PIN, according to an embodiment of the present invention;

FIG. 4C illustrates an operational flow diagram depicting a process for determining the availability status of the PEGC, according to an embodiment of the present invention;

FIG. 4D illustrates an operational flow diagram depicting a process for assigning the new PEGC for the PIN, according to an embodiment of the present invention;

FIG. 5A illustrates a process flow comprising a method for determining the availability status of a PINE, according to an embodiment of the present invention;

FIG. 5B illustrates an operational flow diagram depicting a process for determining the availability status of the PINE, according to an embodiment of the present invention;

FIG. 5C illustrates an operational flow diagram depicting a process for suspending data transmission to a PINE, according to an embodiment of the present invention;

FIG. 6A illustrates a process flow comprising a method for determining the availability status of a PEMC, according to an embodiment of the present invention;

FIG. 6B illustrates a process flow comprising a method for assigning a new PEMC for the PIN, according to an embodiment of the present invention;

FIG. 6C illustrates an operational flow diagram depicting a process for determining the availability status of the PEMC, according to an embodiment of the present invention; and

FIG. 6D illustrates an operational flow diagram depicting a process for assigning the new PEMC for the PIN, according to an embodiment of the present invention.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### MODE FOR THE INVENTION

A personal internet of things (IoT) network (PIN) comprises multiple entities in communication with a core network and/or a PIN server. The entities may include PIN elements (PINEs), a PIN element with gateway capability (PEGC), and a PIN element with management capability (PEMC). The PEGC acts as a gateway for connection among different PINEs, and among the PINEs and the core network. The PEMC acts as a management entity for the PIN. The PINEs may provide or receive various services within the PIN.

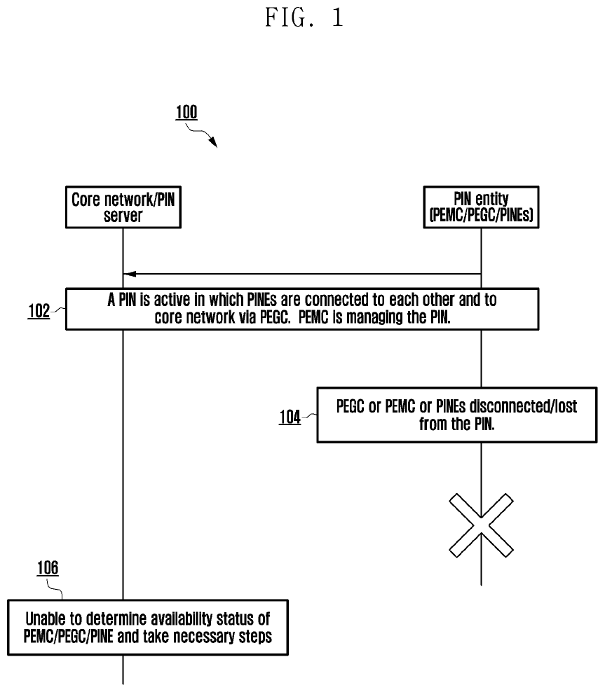

FIG. 1 illustrates an existing operational flow diagram depicting a process when any entity disconnects from a personal internet of things (IoT) network (PIN), in accordance with an existing prior-art. At block 102, a PIN is active in which PINEs are connected to each other and to the core network via PEGC. The PEMC is managing the PIN.

At block 104, the PEGC, the PEMC, or any of the PINEs may be disconnected or lost from the PIN. When the PEGC leaves the PIN, all PINEs being served by the PEGC become disconnected from PIN and the PIN services they offer or need become unavailable to other PINEs. When the PEMC leaves the PIN, the PEGC and all PINEs being managed by the PEMC do not have a serving management entity. When any of the PINEs become unavailable, it may not be possible to provide or receive PIN services from the unavailable PINEs.

At block 106, the core network and/or the PIN server may be unable to determine the availability status of the PEGC, the PEMC, or any of the PINEs that are disconnected. The core network and/or the PIN server may be unable to take any necessary action, for instance, assigning PIN-related functionalities, with respect to the unavailability of the PEGC or the PEMC or any of the PINEs.

Currently, no methods and systems are defined to detect unavailability of entities (PEGC/PEMC/PINEs) within the PIN. The core network and/or PIN server may remain unaware of the availability of the entities. As a result, the PIN functionalities and services may suffer due to the unavailability of the entities within the PIN.

Therefore, there is a need for an improved method and system in order to solve the above-mentioned problems. For instance, there is a need for systems and methods that determine the availability status of entities within the PIN. Further, there is a need for systems and methods that facilitate an assignment of PIN-related functionalities associated with unavailable entities to other entities within the PIN.

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”. “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The present invention is directed towards methods and systems for determining availability status of one or more entities in a personal internet of things (IoT) network (PIN) and assigning PIN-related functionalities to different entities within the PIN. The one or more entities may include one or more PIN Elements (PINEs), a PIN element with gateway capability (PEGC), and a PIN element with management capability (PEMC).

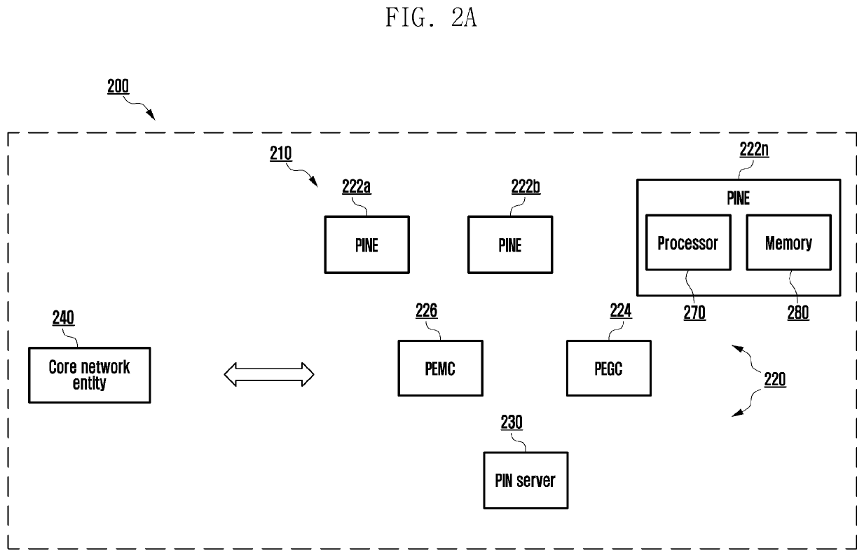

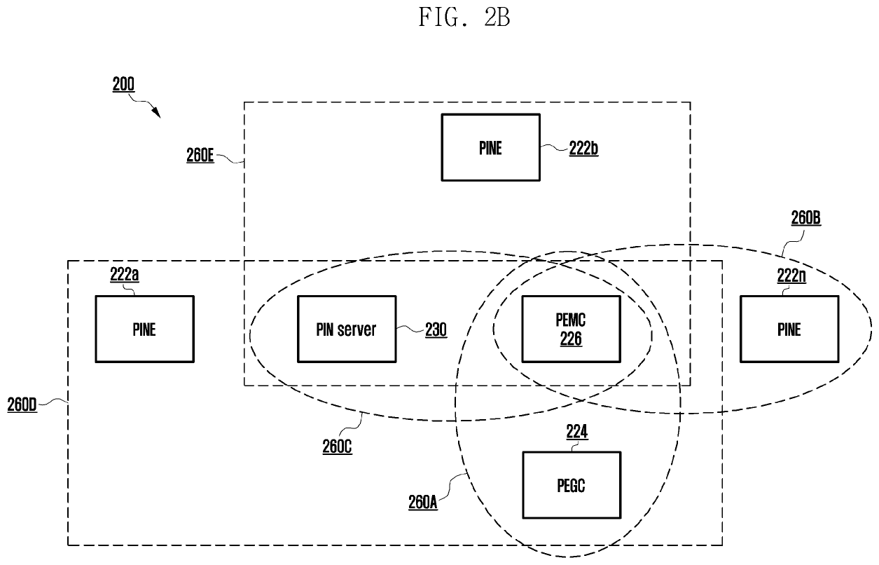

FIG. 2A illustrates a schematic block diagram of an environment 200 for determining the availability status of entities within a personal internet of things (IoT) network (PIN) and facilitating assignment of PIN-related functionalities associated with unavailable entities to other entities within the PIN, in accordance with an embodiment of the present disclosure. The environment 200 may be associated with the PIN 210. The PIN 210 may comprise a plurality of entities 220. The plurality of entities 220 include one or more PIN Elements (PINEs) 222a-222n, a PIN element with gateway capability (PEGC) 224, and a PIN element with management capability (PEMC) 226. In some embodiments, each of the plurality of entities 220 may be associated with a corresponding PIN identifier (PIN-ID).

The environment 200 further comprises a PIN server 230 and a core network entity 240 in communication with the PIN 210 via a communication network. In some embodiments, the core network entity 240 may be a 5G core network entity. In some embodiments, the core network entity 240 may comprise one or more of access and mobility management function (AMF), session management function (SMF), User Plane Function (UPF), policy control function (PCF), unified data management (UDM), and the like. In some embodiments, the PIN server 230 may include a PIN network function (PINNF) and/or a PIN application function (PINAF). In some embodiments, the PINNF may refer to a core network entity responsible for assignment and management of PIN-identifiers (IDs) associated with the plurality of entities 220. In some embodiments, the PINAF may refer to a network function connected to the core network entity 240 via a network exposure function (NEF) and may be configured for policy configuration and provisioning of the PIN 210 and the plurality of entities 220.

In some embodiments, the plurality of entities 220 may be communicatively coupled with each other by means of direct network connections or a PIN direct connection. In some embodiments, the plurality of entities 220 may be communicatively coupled with each other by means of proximity services (ProSe) which allows device-to-device (D2D) communication.

In some embodiments, each of the plurality of entities 220 includes a user equipment (UE) and/or non-3rd generation partnership project (non-3GPP) devices, such as, but not limited to, a smart phone, a smart watch, a tablet, a personal digital assistant (PDA), and/or a laptop.

In some embodiments, the PEGC 224 may be configured to provide connectivity to and from the core network entity 240 for the plurality of entities 220 including the PINEs 222a-222n and the PEMC 226. In some embodiments, the PEGC 224 is configured to facilitate the plurality of entities 220 to register and access networks (for example, 5G network) through the core network entity 240. In some embodiments, the PEGC 224 may be configured to facilitate communication among entities within the PIN 210, such as PINEs that are not within the range to use direct communication. The PEGC 224 may thus act as a gateway for communication among different entities 220, among the entities 220 and the PIN server 230, and among the entities 220 and the core network entity 240.

In some embodiments, the PEMC 226 may be configured to manage the PIN 210. In some embodiments, the PEMC 226 may be associated with an authorized administrator to facilitate configuration and management of the PIN 210.

In some embodiments, the PINEs 222a-222n may be configured to provide an associated service within the PIN 210. The PINEs may include as non-limiting examples, printers, smart thermostats, smart sprinklers, smart blinds, smart garages, and other smart devices.

In some embodiments, the environment 200 comprises one or more systems formed by a combination of the plurality of entities 220, as depicted in FIG. 2B. The environment 200 may comprise a system 260A including the PEGC 224 and the PEMC 226. The environment 200 may comprise a system 260B including the PINE 222n and the PEMC 226. The environment 200 may comprise a system 260C including the PIN server 230 and the PEMC 226. The environment 200 may comprise a system 260D including the PIN server 230, the PEGC 224, the PEMC 226, and one of the plurality of PINEs 222a-222n (here, 222a). The environment 200 may comprise a system 260E including the PIN server 230, the PEGC 224, the PEMC 226, and one of the plurality of PINEs 222a-222n (here, 222b).

It is appreciated that the environment 200 may comprise additional systems formed by various combinations of the plurality of entities 220. That is, the environment 200 may comprise a system formed by a first entity and a second entity of the plurality of entities 220. It is appreciated that the term ‘system’ as used in the present disclosure refers to a system formed by a combination of the plurality of entities 220.

In some embodiments, each entity of the plurality of entities 220 may be associated with a memory and a processor communicatively coupled to the memory. As seen in FIG. 2A, the entity 222n, i.e., the PINE 222n, is shown comprising a processor 270 and a memory 280. It is appreciated that although one or more details may be provided for the processor 270 and the memory 280 of the entity 222n/PINE 222n, the one or more details are equally applicable for the respective processor and memory of each of the plurality of entities 220. The functionalities of the entities 220 may be provided by the respective processor 270 and the respective memory 280.

In some embodiments, the processor 270 and the memory 280 may be on-device units and may be integrated with the entity 222n. In some embodiments, the functionalities of the processor 270 and the memory 280 may be provided through a cloudbased unit in communication with the entity 222n. In some embodiments, the functionalities of the processor 270 and the memory 280 may be provided in a distributed manner, i.e., distributed over the cloud and on-device.

In some embodiments, the processor 270 and the memory 280 may be in communication with one or more modules (not shown). In some embodiments, the one or more modules may be included within the memory 280. The memory 280 may be configured to store data, and instructions executable by the processor 270. The memory 280 may include a database configured to store data. The one or more modules may include a set of instructions that may be executed to cause the respective entities to perform any one or more of the methods disclosed herein, for instance, using the data stored in the database. In an embodiment, each of the one or more modules may be hardware units that may be outside the memory 280. Further, the memory 280 may include an operating system for performing one or more tasks of the respective entities, as performed by a generic operating system in the communications domain.

In some embodiments, the functions, acts, or tasks illustrated in the figures or described may be performed by the programmed processor 270 for executing the instructions stored in the memory 280. The functions, acts, or tasks being performed by an entity may be performed by the respective processor of the entity in conjunction with the respective memory. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

The memory 280 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 280 may include a cache or random-access memory for the processor. In alternative examples, the memory 280 is separate from the processor/controller, such as a cache memory of a processor, the system memory, or other memory.

In one embodiment, the processor 270 may include specialized processing units such as integrated system (bus) controllers, memory management control units, floating point units, graphics processing units, digital signal processing units, etc. In one embodiment, the processor 270 may include a central processing unit (CPU), a graphics processing unit (GPU), or both. The processor 270 may be one or more general processors, digital signal processors, application-specific integrated circuits, field-programmable gate arrays, servers, networks, digital circuits, analog circuits, combinations thereof, or other now-known or later developed devices for analyzing and processing data. The processor 270 may implement a software program, such as code generated manually (i.e., programmed). In some embodiments, the processor 270 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

In some embodiments, each of the plurality of entities 220 may include a transceiver (not shown) and an I/O interface (not shown). The I/O interface may provide a display function and one or more physical buttons on the respective entities. The I/O interface may employ communication code-division multiple access (CDMA), high-speed packet access (HSPA+), global system for mobile communications (GSM), long-term evolution (LTE), WiMax, or the like, etc. In some embodiments, the processor 270 may be disposed in communication with a communication network via a network interface. The network interface may be the I/O interface of the respective entity of the processor 270. The network interface may connect to a communication network. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

For the sake of brevity, the architecture and standard operations of operating system, memory, database, processor, transceiver, and I/O interface are not discussed in detail.

In some embodiments, each of the plurality of entities 220 may be associated with a timer corresponding to a periodic update (PU) timer value. In some embodiments, each of the plurality of entities 220 may be configured to transmit a periodic update request prior to an expiry of the PU timer value to indicate availability within the PIN 210.

In some embodiments, considering a first entity and a second entity of the plurality of entities 220, the availability status of the first entity may be determined. The first entity and the second entity may form a corresponding system. The second entity may be configured to determine whether the periodic update request is received from the first entity prior to the expiry of the PU timer value. The second entity may be configured to determine the availability status of the first entity based on the determination whether the periodic update request is received from the first entity. In some embodiments, the PU timer value may define a periodicity of PU update requests to be transmitted by the first entity to the second entity, in order to indicate the availability of the first entity.

In some embodiments, the second entity may be configured to determine the availability status of the first entity as unavailable within the PIN, upon determining that the periodic update request is not received from the first entity prior to the expiry of the PU timer value. The second entity may be configured to determine the availability status of the first entity as available within the PIN, upon determining that the periodic update request is received from the first entity prior to the expiry of the PU timer value.

It is appreciated that the term “prior to” as used in the present disclosure is intended to mean “on or before”.

In some embodiments, the first entity is the PEGC 224 and the second entity is the PEMC 226, forming a part of the system 260A. In some embodiments, the first entity is a PINE 222n of the plurality of PINES 222a-222n and the second entity is the PEMC 226, forming a part of the system 260B. In some embodiments, the first entity is the PEMC 226 and the second entity is the PIN server 230, forming a part of the system 260C. Accordingly, the availability status of the first entity within the PIN may be determined by the second entity.

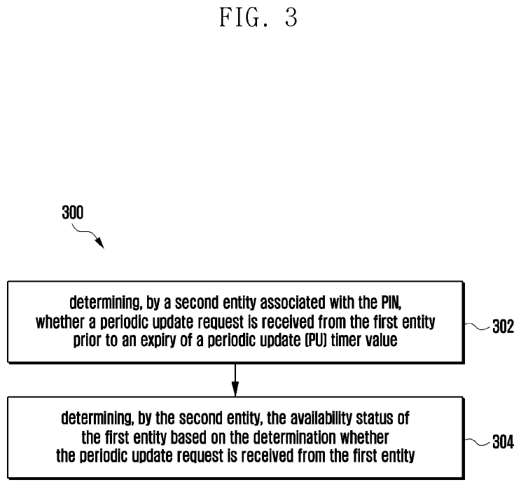

Referring to FIG. 3, an exemplary process flow comprising a method 300 for determining the availability status of the first entity is illustrated, according to one embodiment of the present disclosure. At step 302, the method 300 comprises determining, by the second entity, whether a periodic update request is received from the first entity prior to an expiry of the PU timer value. At step 304, the method 300 comprises determining, by the second entity, the availability status of the first entity based on the determination whether the periodic update request is received from the first entity.

### PEGC Availability and Assigning New PEGC

Referring again to FIGS. 2A-2B, in some embodiments, the PEGC 224 is associated with a timer corresponding to the PU timer value. The PU timer value is assigned to the PEGC 224 by one of the PEMC 226 or the PIN server 230. In some embodiments, the PU timer value may be configured by a user associated with the entities 220 within the PIN 210. In some embodiments, the PEGC 224 may be configured to transmit a periodic update request prior to expiry of the PU timer value to indicate availability within the PIN 210. In some embodiments, the PU timer value may define a periodicity of PU update requests to be transmitted by the PEGC 224 to the PEMC 226, in order to indicate the availability of the PEGC 224.

In some embodiments, the availability status of the PEGC 224 within the PIN 210 may be determined. The system 260A shown in FIG. 2B may comprise the PEMC 226 configured to determine whether the periodic update request is received from the PEGC prior to the expiry of the PU timer value. The PEMC 226 may be configured to determine the availability status of the PEGC 224 based on the determination whether the periodic update request is received from the PEGC 224.

In some embodiments, the PEMC 226 may be configured to determine the availability status of the PEGC 224 as unavailable within the PIN 210, upon determining that the periodic update request is not received from the PEGC 224 prior to the expiry of the PU timer value. The PEMC 226 may be configured to determine the availability status of the PEGC 224 as available within the PIN, upon determining that the periodic update request is received from the PEGC 224 prior to the expiry of the PU timer value. Accordingly, the PEMC 226 may determine the PEGC 224 to be unavailable based on the PU timer value.

When the PEGC 224 is unavailable, the PEGC 224 cannot act as a gateway for connection among various PINEs 222a-222n and among PINEs 222a-222n and the core network entity 240. Thus, all the PINEs 222a-222n may become disconnected from the PIN 210, and the PIN services offered or needed by the PINEs 222a-222n become unavailable.

When the PEGC 224 is unavailable, an entity may be assigned as a new PEGC to provide the functionalities of the PEGC 224. The system 260D as shown in FIG. 2B may comprise the PEMC 226 configured to determine the availability status of the PEGC 224, i.e., the current PEGC, as unavailable within the PIN 210, as described above. The system 260D may comprise the PIN server 230 configured to select a first PINE (say, PINE 222a) from the plurality of PINEs 222a-222n to serve as the new PEGC for the PIN 210. The PIN server 230 may select the first PINE upon the determination by the PEMC 226 that the availability status of the PEGC 224 is unavailable within the PIN 210.

In some embodiments, the PIN server 230 may be configured to select the first PINE based on corresponding PINE capability information associated with each of the plurality of PINEs 222a-222n. In some embodiments, the PINE capability information may be provided by the corresponding PINEs 222a-222n at the time of joining the PIN 210, at the time of registration with the core network entity 240, and/or based on a user input indicative of a capability of the corresponding PINEs 222a-222n. In some embodiments, the PINE capability information may be stored at the PEMC 226 and/or the PIN server 230.

In some embodiments, the PEMC 226 may be configured to send a modification message to the PIN server 230, the modification message being indicative of a request to select the new PEGC for the PIN 210. The PIN server 230 may be configured to select the first PINE upon receiving the modification message. In some embodiments, the modification message may be associated with a protocol data unit (PDU) session modification procedure.

In some embodiments, the PIN server 230 may be configured to send an assignment request to the first PINE (say, PINE 222a). The assignment request may be indicative of an assignment of the first PINE to serve as the new PEGC for the PIN 210. The PIN server 230 may be configured to receive an assignment response from the first PINE. The assignment response may be indicative of acceptance of the first PINE to serve as the new PEGC for the PIN 210. The PIN server 230 or the PEMC 226 may be configured to transmit a notification message to the plurality of PINEs 222a-222n within the PIN 210, the notification message being indicative of the assignment of the first PINE as the new PEGC for the PIN 210.

In some embodiments, the notification message may include information such as fully qualified domain name (FQDN), IP-Address, Port Number, PEGC ID, etc. associated with the new PEGC (i.e., the first PINE). The notification message may further indicate the other PINEs (for instance, if the first PINE is 222a, the other PINEs are 222b-222n) to move from old PEGC 224 and connect to the new PEGC.

In an alternate embodiment, the PEMC 226 and/or the PIN server 230 may broadcast or indicate to a UE outside the PIN 210 to join the PIN 210 to act as the new PEGC for the PIN 210.

In some embodiments, the notification message may additionally be transmitted to the core network entity 240 to indicate an assignment of the new PEGC. It is appreciated that although the notification message is described as being transmitted by the PIN server 230 or the PEMC 226, in an alternate embodiment, the notification message may be transmitted by the core network entity 240 to the PEMC 226, the PIN server 230, and the PINEs 222a-222n.

It is appreciated that although the selection of the new PEGC is described as being performed by the PIN server 230, in alternate embodiments, the selection of the new PEGC may be performed by the PEMC 226.

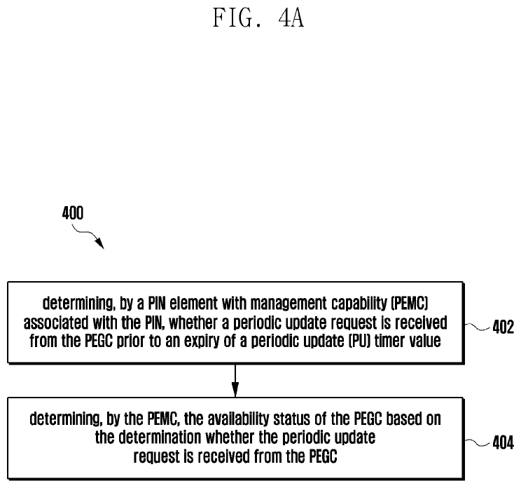

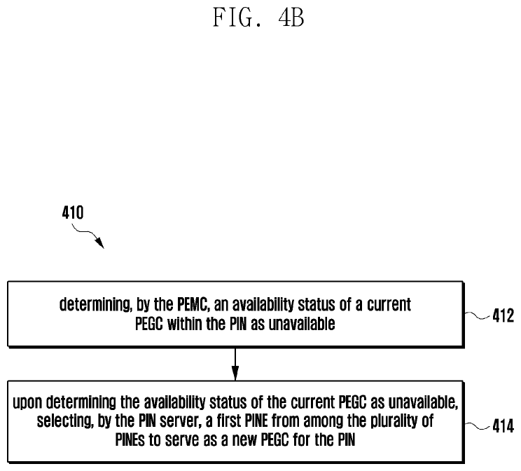

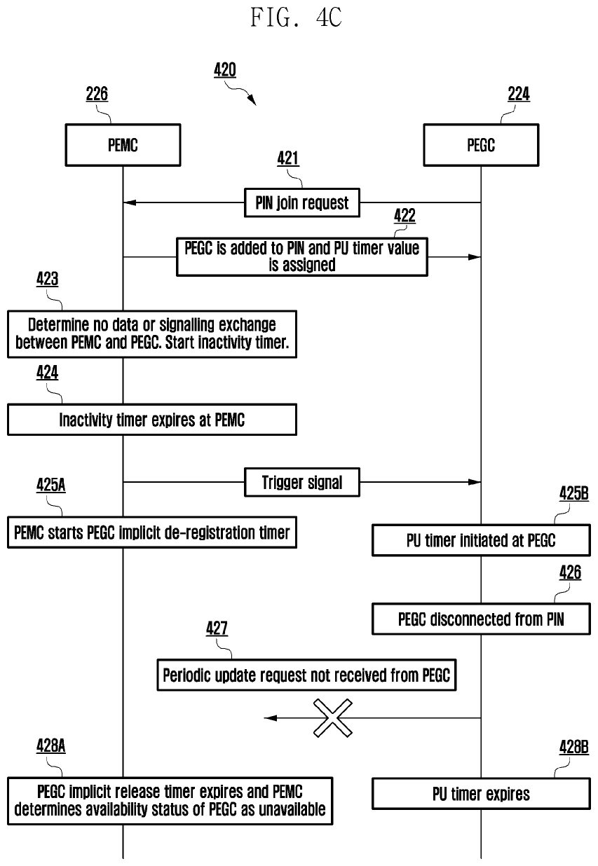

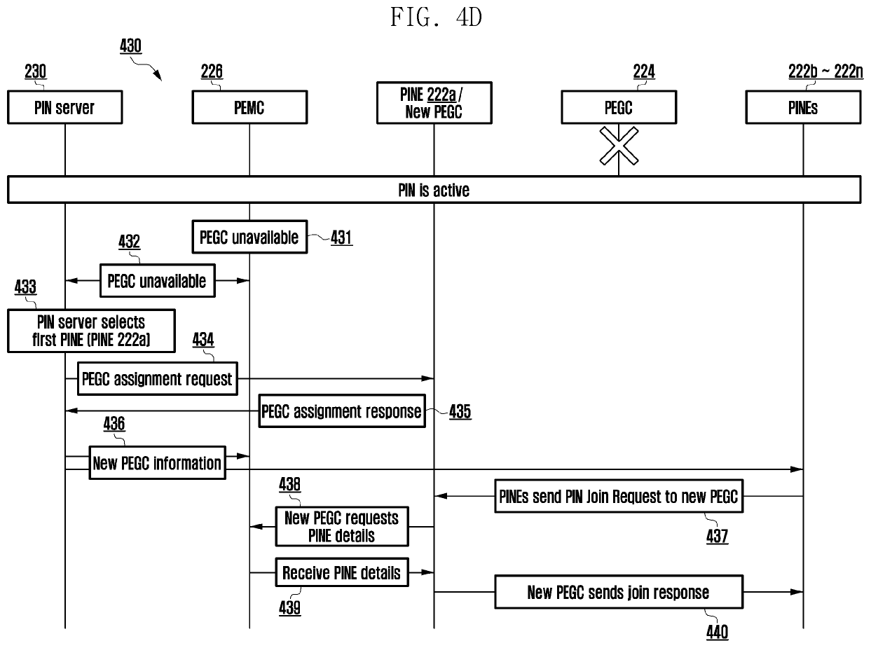

Referring to FIG. 4A, an exemplary process flow comprising a method 400 for determining the availability status of the PEGC 224 is illustrated, according to one embodiment of the present disclosure. The method 400 may be performed at the system 260A. At step 402, the method 400 comprises determining, by the PEMC 226, whether a periodic update request is received from the PEGC 224 prior to an expiry of the PU timer value. At step 404, the method 400 comprises determining, by the PEMC 226, the availability status of the PEGC 224 based on the determination whether the periodic update request is received from the PEGC 224.

Referring to FIG. 4B, an exemplary process flow comprising a method 410 for assigning the new PEGC for the PIN 210 is illustrated, according to one embodiment of the present disclosure. The method 410 may be performed at the system 260D. At step 412, the method 410 comprises determining, by the PEMC 226, an availability status of a current PEGC within the PIN as unavailable. At step 414, the method 410 comprises, upon determining the availability status of the current PEGC as unavailable, selecting, by the PIN server 230, a first PINE from among the plurality of PINEs to serve as a new PEGC for the PIN.

In some embodiments, the method 410 may be performed as a continuation to method 400, i.e., first the unavailability of the PEGC 224 may be determined and then a new PEGC may be assigned thereafter. It is appreciated that a detailed description related to the various steps of FIGS. 4A-4B is already covered in the description related to FIGS. 2A-2B and is omitted herein for the sake of brevity.

Referring to FIG. 4C, an operational flow diagram is illustrated depicting a process 420 for determining the availability status of the PEGC 224, according to one embodiment of the present disclosure. At step 421, a PIN join request is sent by the PEGC 224 to the PEMC 226, the join request being indicative of a request to join the PIN 210. At step 422, the PEMC 226 adds the PEGC 224 to the PIN 210 and assigns the PU timer value to the PEGC 224.

At step 423, the PEMC 226 determines that there is no data or signaling exchange between the PEGC 224 and the PEMC 226. For instance, the PEMC 226 may not have received any data from the PEGC 224. An inactivity timer is initiated at the PEMC 226 upon determining that there is no data or signaling exchange between the PEGC 224 and the PEMC 226. At step 424, the inactivity timer expires at the PEMC 226.

Upon expiry of the inactivity timer, at steps 425A and 425B, corresponding timers at the PEMC 226 and the PEGC 224 are initiated. For instance, the PEMC 226 may send a trigger signal to the PEGC 224 to initiate the corresponding timers. At step 425A, a PEGC implicit de-registration timer is initiated at the PEMC 226. At step 425B, a PU timer may be initiated at the PEGC 224. The PEGC implicit de-registration timer and the PU timer may both correspond to the PU timer value.

At step 426, the PEGC 224 may be disconnected from the PIN 210. For instance, the PEGC 224 may face a coverage loss and/or a signal loss. As an example, the PEGC 224 may be out of the coverage area of the PIN 210. As the PEGC 224 is disconnected from the PIN 210, the PEGC 224 is unable to send the PU update request to the PEMC 226, as depicted at step 427.

At step 428A, the PEGC implicit de-registration timer may expire at the PEMC 226 and at step 428B, the PU timer may expire at the PEGC 224. As no PU update request is received by the PEMC 226 from the PEGC 224 prior to the expiry of the PU timer value (i.e., prior to the expiry of the corresponding timers), the PEMC 226 determines the availability status of the PEGC 224 as unavailable within the PIN 210. In some embodiments, the PEMC 226 may inform other entities, such as, PIN server 230 and PINEs 222a-222n regarding the unavailability of the PEGC 224.

In some embodiments (not shown), in case the PEGC 224 remains connected with the PIN 210 at step 426, then at step 427 the PEGC 224 may send the PU update request to the PEMC 226 prior to the expiry of the PU timer value. The PEMC 226 may receive the PU update request from the PEGC 224 and determine the availability status of the PEGC 224 to be available within the PIN 210.

It is appreciated that although the determination of the availability status of the PEGC 224 is described as being determined by the PEMC 226, in alternate embodiments, any one of the PINEs 222a-222n may determine the availability status of the PEGC 224 in the manner as described above.

In an alternate embodiment, the core network entity 240) may determine the availability status of the PEGC 224. When the PEGC 224 disconnects from the PIN 210, such as due to powering off, low battery, switching to disconnected mode, and the like, the PEGC 224 may enter a deregistered state (for instance, ‘5GMM_DEREGISTERED’ state) and sends a deregistration request to the core network entity 240. The core network entity 240 may receive the deregistration request and determine the PEGC 224 to be unavailable within the PIN 210.

In another alternate embodiment, the core network entity 240 may determine PEGC unavailability based on mobility reachability timer and/or implicit deregistration time expiry.

In yet another alternate embodiment, the core network entity 240 may determine the availability status of the PEGC 224 as unavailable based on whether single network slice selection assistance information (S-NSSAI) dedicated for the PIN 210 is not allowed or is part of a rejected NSSAI list.

In yet another alternate embodiment, the core network entity 240 may determine the availability status of the PEGC 224 as unavailable if the PEGC 224 handovers and/or reselects from a first radio access technology (RAT) to a second RAT. For example, the PEGC 224 may handover from a 5G network to Long-Term Evolution (LTE) or Wideband Code Division Multiple Access (WCDMA). In another example, the PEGC 224 may register to a roaming PLMN. The PEGC 224 may perform intersystem change and the core network entity 240 (for instance, AMF, SMF, UDM) may determine the PEGC 224 to be unavailable.

Referring to FIG. 4D, an operational flow diagram is illustrated depicting a process 430 for assigning a new PEGC for the PIN 210, according to one embodiment of the present disclosure. At step 431, the PEMC 226 may determine that the PEGC 224 (i.e., the current PEGC) is unavailable within the PIN 210. At step 432, the PEMC 226 may inform the PIN server 230 regarding the unavailability of the PEGC 224.

At step 433, the PIN server 230 may select the first PINE, say PINE 222a from among the plurality of PINEs 222a-222n, as the new PEGC for the PIN 210. The selection may be based on PIN capability associated with the plurality of PINEs 222a-222n. At step 434, the PIN server 230 may send an assignment request to the new PEGC, i.e., the first PINE. At step 435, the PIN server 230 may receive an assignment response from the new PEGC. At step 436, the PIN server 230 may transmit information associated with the new PEGC to the PEMC 226 and to other PINEs, say PINEs 222b-222n. In some embodiments, the information associated with the new PEGC may be sent as indications or may be broadcasted.

In alternate embodiments, the steps 433-436 may be performed by the PEMC 226. In some embodiments, the PEMC 226 may transmit information associated with the new PEGC to the other PINEs.

At step 437, the other PINEs may send corresponding join requests to the new PEGC. In some embodiments, the corresponding join requests may include corresponding PINE IDs assigned by the old PEGC 224. In some embodiments, the join request may be of the type ‘reconnect’, to indicate that the other PINEs are moving from old PEGC to new PEGC.

At step 438, the new PEGC may request details associated with the other PINEs from the PEMC 226 based on the corresponding PINE IDs of the other PINEs. At step 439, the PEMC 226 may send the details associated with the PINEs to the new PEGC. At step 440, the new PEGC may send join responses to the other PINEs indicating acceptance of the corresponding join requests. In some embodiments, the join responses may include new PINE IDs for the other PINEs. In some embodiments, the new PEGC may utilize the PINE IDs assigned by the old PEGC 224 instead of assigning new PINE IDs. In some embodiments, the new PEGC may update the details associated with the other PINEs at one or more of the PEMC 226, the PIN server 230, and the core network entity 240, for instance, a using PDU session modification procedure.

As described with reference to FIGS. 2 and 4A-4D, the unavailability of the PEGC 224 within the PIN 210 can be detected in a reliable manner. There would be no loss of connections among the entities within the PIN 210 as a new PEGC may be assigned upon detection of the unavailability of the PEGC 224.

### PINE Availability and Suspending Data Transmission

Referring again to FIGS. 2A-2B, in some embodiments, each of the PINEs 222a-222n are associated with a timer corresponding to the periodic update (PU) timer value. The PU timer value is assigned to the PINEs 222a-222n by one of the PEGC 224, the PEMC 226, or the PIN server 230. In some embodiments, the PU timer value may be configured by a user associated with the entities 220 within the PIN 210. In some embodiments, the PU timer value may be pre-configured within the PINEs 222a-222n.

In some embodiments, the availability status of the PINEs 222a-222n within the PIN 210 may be determined. It is appreciated that details may be explained with reference to PINE 222n, however, the details are equally applicable for other PINEs as well. The system 260B as shown in FIG. 2B may comprise the PEMC 226 configured to determine whether the periodic update request is received from the PINE 222n prior to the expiry of the PU timer value. The PEMC 226 may be configured to determine the availability status of the PINE 222n based on the determination whether the periodic update request is received from the PINE 222n.

In some embodiments, the PEMC 226 may be configured to determine the availability status of the PINE 222n as unavailable within the PIN 210, upon determining that the periodic update request is not received from the PINE 222n prior to the expiry of the PU timer value. The PEMC 226 may be configured to determine the availability status of the PINE 222n as available within the PIN, upon determining that the periodic update request is received from the PINE 222n prior to the expiry of the PU timer value. Accordingly, the PEMC 226 may determine the PINE 222n to be unavailable based on the PU timer value.

In some embodiments, when the PINE 222n is unavailable, the PEMC 226 may establish a non-3GPP access connection with the PINE 222n and request the PINE 222n to send a PIN join request prior to the PINE 222n being de-registered from the PIN 210. The PEMC 226 may start a second timer and wait for PINE to send the PU update request at the expiry of the second timer. In case no PU update request is received from the PINE 222n, the PINE 222n may be de-registered from the PIN 210.

In some embodiments, the PINE 222n may join the PIN over non-3GPP access. The PINE 222n may face link-loss with the PEMC 226 over the non-3GPP access. When link-loss is detected, the respective timers at the PEMC 226 and the PINE 222n may start, the respective timers corresponding to the PU timer value. In case the link recovers, the corresponding timers stop at the PEMC 226 and the PINE 222n and the PINE 222n is able to send a packet to the PEMC 226. In case the link does not recover, the PINE 222n fails to send the PU update request to the PEMC 226 and the PINE 222n is determined as unavailable.

In some embodiments, when the PINE 222n is unavailable, data transmission to the PINE 222n may be suspended. The PINE 222n may be unable to receive downlink data due to link-loss or being unreachable. As the PINE 222n is unavailable, the PEGC 224 may be configured to send a signal, such as by PDU session modification procedure, to the core network entity 240, the signal indicating unavailability of the PINE 222n and/or release from PINE 222n from the PIN 210. The PINE 222n may be released from the PIN 210 by the PEMC 226. In some embodiments, the PEGC 224 may send a signal to the PEMC 226 to release the PINE 222n. Further, one of the PEMC 226 or the PEGC 224 may be configured to indicate release of the PINE 222n to the core network entity 240 and/or the PIN server 230, and in response, the core network entity 240 and/or the PIN server 230 may suspend data transmission to the PINE 222n.

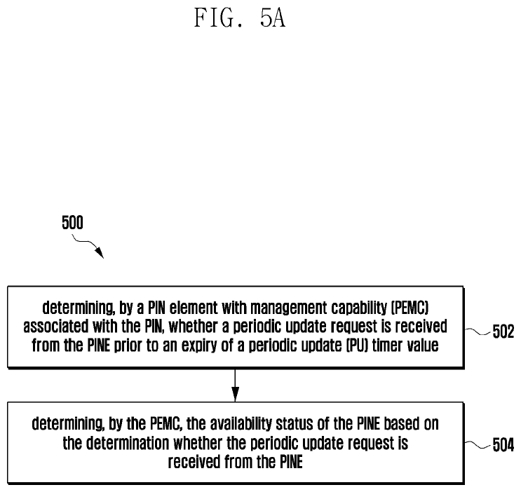

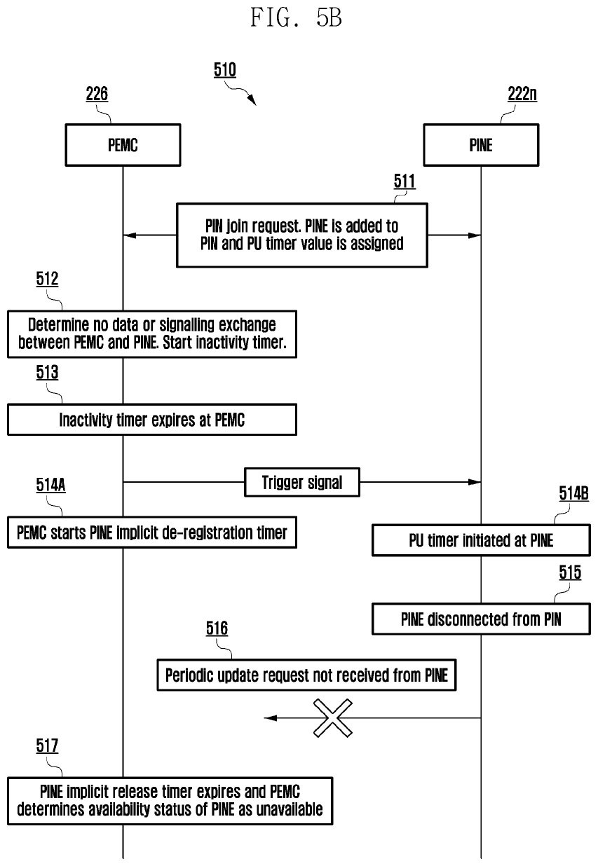

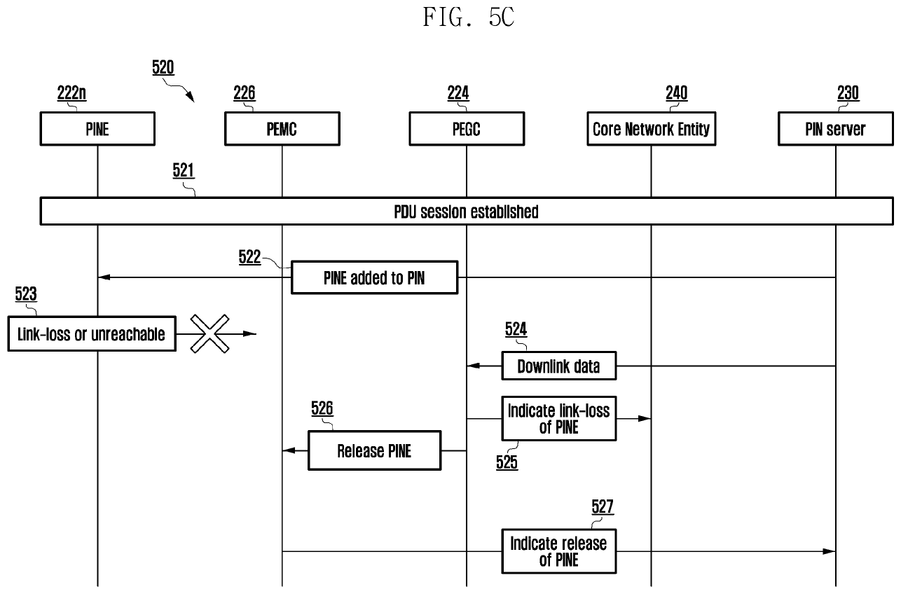

Referring to FIG. 5A, an exemplary process flow comprising a method 500 for determining the availability status of the PINE 222n is illustrated, according to one embodiment of the present disclosure. The method 400 may be performed at the system 260B. At step 502, the method 500 comprises determining, by the PEMC 226, whether a periodic update request is received from the PINE 222n prior to an expiry of the PU timer value. At step 504, the method 500 comprises determining, by the PEMC 226, the availability status of the PINE 222n based on the determination whether the periodic update request is received from the PINE 222n.

Referring to FIG. 5B, an operational flow diagram is illustrated depicting a process 510 for determining the availability status of the PINE 222n, according to one embodiment of the present disclosure. At step 511, a PIN join request is sent by the PINE 222n to the PEMC 226, the join request being indicative of a request to join the PIN 210. The PEMC 226 adds the PINE 222n to the PIN 210 and assigns the PU timer value to the PINE 222n. In some embodiments, the PU timer value may be assigned to the PINE 222n by the PEGC 224 or the PIN server 230.

At step 512, the PEMC 226 determines that there is no data or signaling exchange between the PINE 222n and the PEMC 226. For instance, the PEMC 226 may not have received any data from the PINE 222n. An inactivity timer is initiated at the PEMC 226 upon determining that there is no data or signaling exchange between the PINE 222n and the PEMC 226. At step 513, the inactivity timer expires at the PEMC 226.

Upon expiry of the inactivity timer, at steps 514A and 514B, corresponding timers at the PEMC 226 and the PINE 222n are initiated. For instance, the PEMC 226 may send a trigger signal to the PINE 222n to initiate the corresponding timers. At step 514A, a PINE implicit de-registration timer is initiated at the PEMC 226. At step 514B, a PU timer may be initiated at the PINE 222n. The PINE 222n implicit de-registration timer and the PU timer may both correspond to the PU timer value.

At step 515, the PINE 222n may be disconnected from the PIN 210. For instance, the PINE 222n may face a coverage loss and/or a signal loss. As an example, the PINE 222n may be out of the coverage area of the PIN 210. As another example, the PINE 222n may lose non-3GPP access signal, such as Bluetooth or WiFi access. As another example, the PINE 222n may go into IDLE mode over non-3GPP access, or a signaling connection is released. As the PINE 222n is disconnected from the PIN 210, the PINE 222n is unable to send the PU update request to the PEMC 226, as depicted at step 516.

At step 517, the PINE implicit de-registration timer may expire at the PEMC 226. The PU timer may also expire at the PINE 222n. As no PU update request is received by the PEMC 226 from the PINE 222n prior to the expiry of the PU timer value (i.e., prior to the expiry of the corresponding timers), the PEMC 226 determines the availability status of the PINE 222n as unavailable within the PIN 210. In some embodiments, the PEMC 226 may inform other entities, such as, PIN server 230 and PEGC 224 regarding the unavailability of the PINE 222n.

In some embodiments (not shown), in case the PINE 222n remains connected with the PIN 210 at step 515, then at step 516 the PINE 222n may send the PU update request to the PEMC 226 prior to the expiry of the PU timer value. The PEMC 226 may receive the PU update request from the PINE 222n and determine the availability status of the PINE 222n to be available within the PIN 210.

It is appreciated that although the determination of the availability status of the PINE 222n is described as being determined by the PEMC 226, in alternate embodiments, the PEGC 224 may determine the availability status of the PINE 222n, the PIN server 230, or the core network entity 240 in the manner as described above.

Referring to FIG. 5C, an operational flow diagram is illustrated depicting a process 520 for suspending data transmission to the PINE 222n, according to one embodiment of the present disclosure. At step 521, a PDU session may be established for the PIN 210 in communication with the core network entity 240. At step 522, the PINE 222n may be added to the PIN 210 by the PIN server 230. At step 523, the PINE 222n may face link-loss or may be unreachable. Thus, connection is lost between the PINE 222n and the PEMC 226/PEGC 224.

At step 524, downlink data to be sent to the PINE 222n may be received at the PEGC 224 from the PIN server 230. In some embodiments, the downlink data may be received using one or more of the IP addresses, Port Number, FQDN, or PINE-ID associated with the PINE 222n. At step 525, the PEGC 224 may send a signal to the core network entity 240 (such as SMF) indicating a link-loss of the PINE 222n. At step 526, the PEGC 224 may send a signal to the PEMC 226 to release the PINE 222n from the PIN 210, and the PINE 222n may be released by the PEMC 226. At step 527, one of the PEMC 226 or the PEGC 224 may indicate release of the PINE 222n to the core network entity 240 and/or the PIN server 230, and in response, the core network entity 240 and/or the PIN server 230 may suspend data transmission to the PINE 222n.

As described with reference to FIGS. 2 and 5A-5C, the unavailability of the PINE 222n within the PIN 210 can be detected in a reliable manner, and in case of unavailability, data transmission may be suspended.

### PEMC Availability and Assigning New PEMC

Referring again to FIGS. 2A-2B, in some embodiments, the PEMC 226 is associated with a timer corresponding to the PU timer value. The PU timer value is assigned to the PEMC 226 by one of the PEGC 224 or the PIN server 230. In some embodiments, the PU timer value may be configured by a user associated with the entities 220 within the PIN 210. In some embodiments, the PEMC 226 may be configured to transmit a periodic update request prior to the expiry of the PU timer value to indicate availability within the PIN 210. In some embodiments, the PU timer value may define a periodicity of PU update requests to be transmitted by the PEMC 226 to the PIN server 230, in order to indicate the availability of the PEMC 226.

In some embodiments, the availability status of the PEMC 226 within the PIN 210 may be determined. The system 260C as shown in FIG. 2B may comprise the PIN server 230 configured to determine whether the periodic update request is received from the PEMC prior to the expiry of the PU timer value. The PIN server 230 may be configured to determine the availability status of the PEMC 226 based on the determination whether the periodic update request is received from the PEMC 226.

In some embodiments, the PIN server 230 may be configured to determine the availability status of the PEMC 226 as unavailable within the PIN 210, upon determining that the periodic update request is not received from the PEMC 226 prior to the expiry of the PU timer value. The PIN server 230 may be configured to determine the availability status of the PEMC 226 as available within the PIN, upon determining that the periodic update request is received from the PEMC 226 prior to the expiry of the PU timer value. Accordingly, the PIN server 230 may determine the PEMC 226 to be unavailable based on the PU timer value.

When the PEMC 226 is unavailable, the PEMC 226 cannot act as a management entity for the PIN 210 to manage the PEGC 224 and the PINEs 222a-222n. Thus, the PIN 210 may not function properly due to the unavailability of the PEMC 226. For instance, functions such as adding new PINE or termination of PIN may not be performed.

When the PEMC 226 is unavailable, an entity may be assigned as a new PEMC to provide the functionalities of the PEMC 226. With reference to the system 260E as shown in FIG. 2B, one of the PEGC 224 or the PIN server 230 may be configured to determine the availability status of the PEMC 226, i.e., the current PEMC, as unavailable within the PIN 210, as described above. One of the PEGC 224 or the PIN server 230 may be configured to select a first PINE (say, PINE 222b) from the plurality of PINEs 222a-222n to serve as the new PEMC for the PIN 210. The PEGC 224 or the PIN server 230 may select the first PINE upon the determination that the availability status of the PEMC 226 is unavailable within the PIN 210.

In some embodiments, the PEGC 224 or the PIN server 230 may be configured to select the first PINE based on corresponding PINE capability information associated with each of the plurality of PINEs 222a-222n. In some embodiments, the PINE capability information may be provided by the corresponding PINEs 222a-222n at the time of joining the PIN 210, at the time of registration with the core network entity 240, and/or based on a user input indicative of the capability of the corresponding PINEs 222a-222n.

In some embodiments, the PEGC 224 or the PIN server 230 may be configured to send an assignment request to the first PINE (say, PINE 222b). The assignment request may be indicative of an assignment of the first PINE to serve as the new PEMC for the PIN 210. The PEGC 224 or the PIN server 230 may be configured to receive an assignment response from the first PINE. The assignment response may be indicative of acceptance of the first PINE to serve as the new PEMC for the PIN 210. The PIN server 230 or the PEGC 224 may be configured to transmit a notification message to the plurality of PINEs 222a-222n within the PIN 210, the notification message being indicative of the assignment of the first PINE as the new PEMC for the PIN 210.

In some embodiments, the notification message may include information such as fully qualified domain name (FQDN), IP-Address, Port Address, PEMC ID, etc. associated with the new PEMC (i.e., the first PINE). The notification message may further indicate the other PINEs (for instance, if the first PINE is 222b, the other PINEs are 222a and 222c-222n) to move from old PEMC 226 and connect to the new PEGC.

In an alternate embodiment, the PEGC 224 and/or the PIN server 230 may broadcast or indicate to a UE outside the PIN 210 to join the PIN 210 to act as the new PEMC for the PIN 210.

In some embodiments, the notification message may additionally be transmitted to the core network entity 240 to indicate the assignment of the new PEMC. It is appreciated that although the notification message is described as being transmitted by the PIN server 230 or the PEGC 224, in an alternate embodiment, the notification message may be transmitted by the core network entity 240 to the PEGC 224, the PIN server 230, and the PINEs 222a-222n.

It is appreciated that although the selection of the new PEMC is described as being performed by the PIN server 230, in alternate embodiments, the selection of the new PEGC may be performed by the PEGC 224, the core network entity 240, or any of the plurality of PINEs.

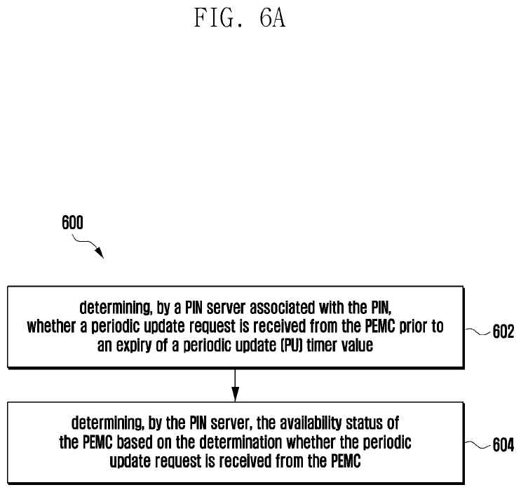

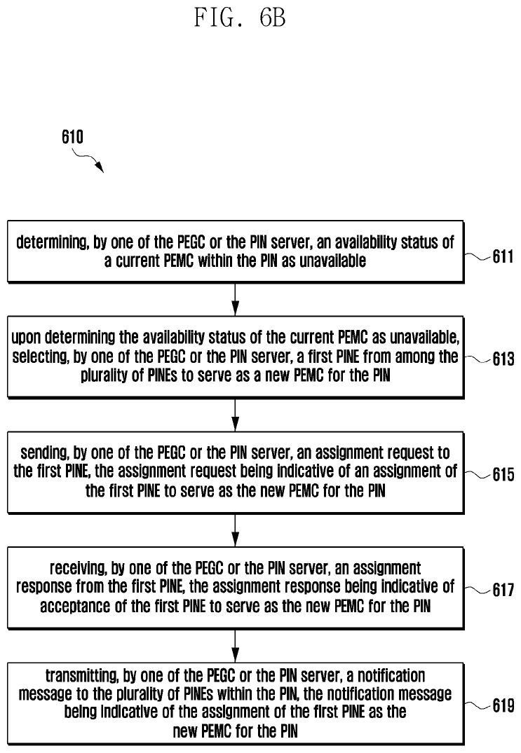

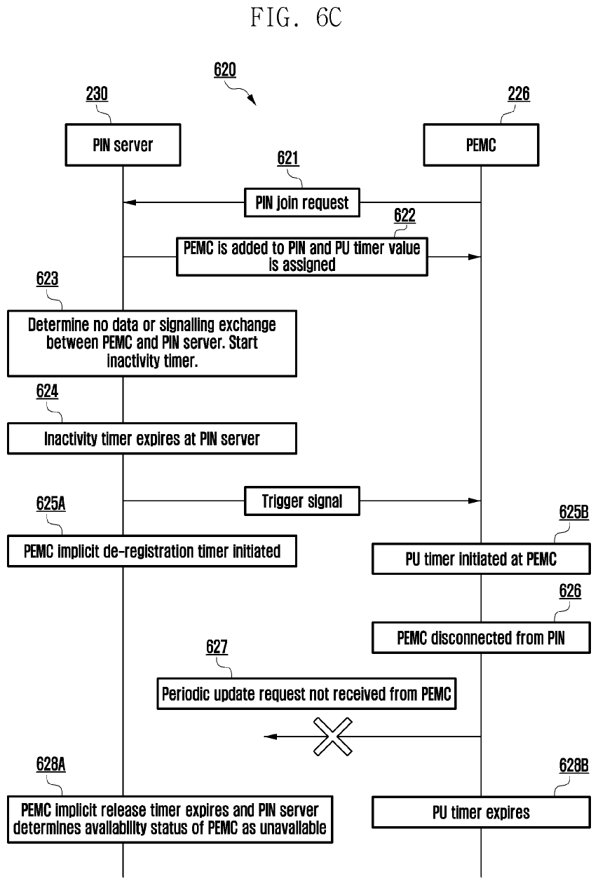

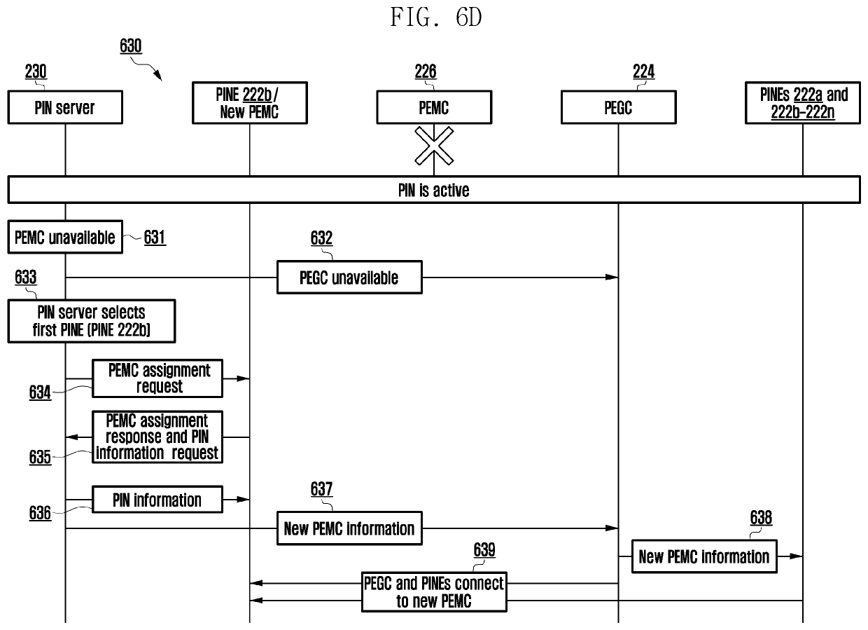

Referring to FIG. 6A, an exemplary process flow comprising a method 600 for determining the availability status of the PEMC 226 is illustrated, according to one embodiment of the present disclosure. The method 600 may be performed at the system 260C. At step 602, the method 600 comprises determining, by the PIN server 230, whether a periodic update request is received from the PEMC 226 prior to an expiry of the PU timer value. At step 604, the method 600 comprises determining, by the PIN server 230, the availability status of the PEMC 226 based on the determination whether the periodic update request is received from the PEMC 226.

Referring to FIG. 6B, an exemplary process flow comprising a method 610 for assigning the new PEMC for the PIN 210 is illustrated, according to one embodiment of the present disclosure. The method 610 may be performed at the system 260E. At step 611, the method 610 comprises determining, by one of the PEGC 224 or the PIN server 230, an availability status of a current PEMC (PEMC 226) within the PIN as unavailable. At step 613, the method 610 comprises upon determining the availability status of the current PEMC as unavailable, selecting, by one of the PEGC or the PIN server, a first PINE from among the plurality of PINEs to serve as a new PEMC for the PIN. At step 615, the method 610 comprises sending, by one of the PEGC 224 or the PIN server 230, an assignment request to the first PINE, the assignment request being indicative of an assignment of the first PINE to serve as the new PEMC for the PIN. At step 617, the method 610 comprises receiving, by one of the PEGC 224 or the PIN server 230, an assignment response from the first PINE, the assignment response being indicative of acceptance of the first PINE to serve as the new PEMC for the PIN. At step 619, the method 610 comprises transmitting, by one of the PEGC 224 or the PIN server 230, a notification message to the plurality of PINEs within the PIN, the notification message being indicative of the assignment of the first PINE as the new PEMC for the PIN 210.

In some embodiments, the method 610 may be performed as a continuation to method 600, i.e., first the unavailability of the PEMC 226 may be determined and then a new PEMC may be assigned thereafter. It is appreciated that a detailed description related to the various steps of FIGS. 6A-6B is already covered in the description related to FIGS. 2A-2B and is omitted herein for the sake of brevity.

Referring to FIG. 6C, an operational flow diagram is illustrated depicting a process 620 for determining the availability status of the PEMC 226, according to one embodiment of the present disclosure. At step 621, a PIN join request is sent by the PEMC 226 to the PIN server 230, the join request being indicative of a request to join the PIN 210. At step 622, the PEMC 226 is added to the PIN 210, and the PU timer value is assigned to the PEMC 226. The PU timer value may be assigned by the PIN server 230 or the PEGC 224.

At step 623, the PIN server 230 determines that there is no data or signaling exchange between the PIN server 230 and the PEMC 226. For instance, the PIN server 230 may not have received any data from the PEMC 226. An inactivity timer is initiated at the PIN server 230 upon determining that there is no data or signaling exchange between the PIN server 230 and the PEMC 226. At step 624, the inactivity timer expires at the PIN server 230.

Upon expiry of the inactivity timer, at steps 625A and 625B, corresponding timers at the PIN server 230 and the PEGC 224 are initiated. For instance, the PIN server 230 may send a trigger signal to the PEMC 226 to initiate the corresponding timers. At step 625A, a PEMC implicit de-registration timer is initiated at the PIN server 230. At step 625B, a PU timer may be initiated at the PEMC 226. The PEMC implicit de-registration timer and the PU timer may both correspond to the PU timer value.

At step 626, the PEMC 226 may be disconnected from the PIN 210. For instance, the PEMC 226 may face a coverage loss and/or a signal loss. As an example, the PEMC 226 may be out of the coverage area of the PIN 210. As the PEMC 226 is disconnected from the PIN 210, the PEMC 226 is unable to send the PU update request to the PIN server 230, as depicted at step 627.

At step 628A, the PEGC implicit de-registration timer may expire at the PIN server 230 and at step 628B, the PU timer may expire at the PEMC 226. As no PU update request is received by the PIN server 230 from the PEMC 226 prior to the expiry of the PU timer value (i.e., prior to the expiry of the corresponding timers), the PIN server 230 determines the availability status of the PEMC 226 as unavailable within the PIN 210. In some embodiments, the PIN server 230 may inform other entities, such as, PEGC 224 and PINEs 222a-222n regarding the unavailability of the PEMC 226.

In some embodiments (not shown), in case the PEMC 226 remains connected with the PIN 210 at step 626, then at step 627 the PEMC 226 may send the PU update request to the PIN server 230 prior to the expiry of the PU timer value. The PIN server 230 may receive the PU update request from the PEMC 226 and determine the availability status of the PEMC 226 to be available within the PIN 210.

It is appreciated that although the determination of the availability status of the PEMC 226 is described as being determined by the PIN server 230, in alternate embodiments, the PEGC 224 or any one of the PINEs 222a-222n may determine the availability status of the PEMC 226 in the manner as described above.

In an alternate embodiment, the core network entity 240 may determine the availability status of the PEMC 226. When the PEMC 226 disconnects from the PIN 210, such as due to powering off, low battery, switching to disconnected mode, and the like, the PEMC 226 may enter a deregistered state (for instance, ‘5GMM_DEREGISTERED’ state) and sends a deregistration request to the core network entity 240. The core network entity 240 may receive the deregistration request and determine the PEMC 226 to be unavailable within the PIN 210.

In another alternate embodiment, the core network entity 240 may determine PEMC unavailability based on mobility reachability timer and/or implicit deregistration time expiry.

In yet another alternate embodiment, the core network entity 240 may determine the availability status of the PEMC 226 as unavailable based on whether single network slice selection assistance information (S-NSSAI) dedicated for the PIN 210 is not allowed or is part of a rejected NSSAI list.

In yet another alternate embodiment, the core network entity 240 may determine the availability status of the PEMC 226 as unavailable if the PEMC 226 handovers and/or reselects from a first radio access technology (RAT) to a second RAT. For example, the PEMC 226 may handover from a 5G network to Long-Term Evolution (LTE) or Wideband Code Division Multiple Access (WCDMA). In another example, the PEMC 226 may register to a roaming PLMN. The PEMC 226 may perform intersystem change and the core network entity 240) (for instance, AMF, SMF, UDM) may determine the PEMC 226 to be unavailable.

Referring to FIG. 6D, an operational flow diagram is illustrated depicting a process 630 for assigning a new PEMC for the PIN 210, according to one embodiment of the present disclosure. The PIN 210 is active and the PEMC 226 is serving as a management entity. At step 631, the PIN server 230 may determine that the PEMC 226 (i.e., the current PEMC) is unavailable within the PIN 210. At step 632, the PIN server 230 may inform the PEGC 224 regarding the unavailability of the PEMC 226, such as, through a PDU session modification procedure.

At step 633, the PIN server 230 may select the first PINE, say PINE 222b from among the plurality of PINEs 222a-222n, as the new PEMC for the PIN 210. The selection may be based on PIN capability associated with the plurality of PINEs 222a-222n. At step 634, the PIN server 230 may send an assignment request to the new PEMC. i.e., the first PINE. At step 635, the PIN server 230 may receive an assignment response and a PIN information request from the new PEMC. At step 636, the PIN server 230 may transmit PIN information to the new PEMC. At step 637, the PIN server 230 may transmit information associated with the new PEMC to the PEGC 224. In some embodiments, the information associated with the new PEMC may include FQDN and IP-Address for the new PEMC. At step 638, the PEGC 224 may transmit information associated with the new PEMC to the other PINEs, say PINEs 222a and 222c-222n. In some embodiments, the information associated with the new PEGC may be sent as indications or may be broadcasted. At step 639, the PEGC 224 and the other PINEs may connect with the new PEMC. In some embodiments, the new PEMC may update PIN information with the PIN server 230 and/or the core network entity 240, such as, by using a PDU session modification procedure.

As described with reference to FIGS. 2 and 6A-6D, the unavailability of the PEMC 226 within the PIN 210 can be detected in a reliable manner. There would be no management-related errors among the entities within the PIN 210 as a new PEMC may be assigned upon detection of the unavailability of the PEMC 226.

The present invention provides for various technical advancements based on the key features discussed above. The present invention provides systems and methods that allow reliable detection of the availability status of entities within the PIN, such as, the availability status of PEGC, PEMC, and PINEs. Further, in case of unavailability of PEGC and PEMC, a new PEGC and a new PEMC respectively may be assigned to avoid interruption in PIN-related functionalities. Furthermore, in case of unavailability of a PINE, data transmission may be suspended for the unavailable PINE. Furthermore, in case of unavailability of PINE(s) when PINE is lost or disconnected from the PIN, the list of available services can be updated at PEMC, at PEGC and at the PIN Server.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A method by an entity associated with a personal internet of things, IoT, network, PIN, element with management capability, PEMC, in a wireless communication system, the method comprising:
transmitting, to a PIN server, a request message;
receiving, from the PIN server, a response message as a response to the request message, wherein the response message includes information associated with a periodic timer;
based on expiry of the periodic timer, receiving, from a PIN element, PINE, a first message associated with updating the periodic timer; and
in case that the first message is received, updating a PINE availability.

2. The method of claim 1, wherein the periodic timer is associated with determining the PINE availability.

3. The method of claim 1, further comprising:
in case that the first message is not received, determining the PINE is unavailable.

4. The method of claim 1, further comprising:
receiving, from a PIN element with gateway capability, PEGC, a second message associated with a PEGC availability.

5. The method of claim 4, further comprising:
in case that the second message is not received, determining the PECG is unavailable; and
transmitting, to the PIN server, a third message includes information associated with a new PEGC.

6. A method by a server associated with a personal internet of things, IoT, network, PIN, in a wireless communication system, the method comprising:
receiving, from a PIN element with management capability, PEMC, a message based on expiry of a periodic timer, wherein the message is associated with updating the periodic timer; and
updating a PEMC availability in case that the message is received.

7. The method of claim 6, further comprising:
in case that the message is not received, determining the PEMC is unavailable.

8. An entity associated with a personal internet of things, IoT, network, PIN, element with management capability, PEMC, in a wireless communication system, the entity comprising:
a transceiver, and
a controller coupled with the transceiver and configured to:
transmit, to a PIN server, a request message;
receive, from the PIN server, a response message as a response to the request message, wherein the response message includes information associated with a periodic timer;
based on expiry of the periodic timer, receive, from a PIN element, PINE, a first message associated with updating the periodic timer; and
in case that the first message is received, update a PINE availability.

9. The entity of claim 8, wherein the periodic timer is associated with determining the PINE availability.

10. The entity of claim 8, wherein the controller is further configured to:
in case that the first message is not received, determine the PINE is unavailable.

11. The entity of claim 8, wherein the controller is further configured to:
receive, from a PIN element with gateway capability, PEGC, a second message associated with a PEGC availability.

12. The entity of claim 11, wherein the controller is further configured to:
in case that the second message is not received, determine the PECG is unavailable; and
transmit, to the PIN server, a third message includes information associated with a new PEGC.

13. A server associated with a personal internet of things, IoT, network, PIN, in a wireless communication system, the server comprising:
a memory configured to store data; and
a processor coupled to the memory and configured to:
receive, from a PIN element with management capability, PEMC, a message based on expiry of a periodic timer, wherein the message is associated with updating the periodic timer; and
update a PEMC availability in case that the message is received.

14. The server of claim 13, a processor is further configured to:
in case that the message is not received, determine the PEMC is unavailable.
